(19) United States
(12) Patent Application Publication
(10) Pub. No.: US 2004/0105249 A1
(43) Pub. Date: Jun. 3, 2004

(54) Light guide plate and surface light source device

(76) Inventors: Tai-Cheng Yu, Tu-Chen (TW); Ching Yen Lee, Tu-chen (TW); YunZhang Chen, Tu-chen (TW); Charles Leu, Fremont, CA (US); Ga-Lane Chen, Fremont, CA (US)

Correspondence Address: WEI TE CHUNG, FOXCONN INTERNATIONAL, INC., 1650 MEMOREX DRIVE, SANTA CLARA, CA, 95050, US

(21) Appl. No.: 10/654,245

(22) Filed: Sep. 2, 2003

(30) Foreign Application Priority Data
Nov. 29, 2002 (TW) 91219303

(51) Int. Cl. F21V 7/04

(52) U.S. Cl. 362/31; 362/26

(57) ABSTRACT

A light guide plate (2) into which light beams are introduced from a light source (41) includes an incident surface (20) receiving the light beams from the light source; a light emitting surface (22) transmitting light beams outwardly; a bottom surface (21) opposite the light emitting surface for reflecting the light beams to the light emitting surface; and a plurality of sidewalls (24, 26, 28) perpendicular to the light emitting surface. The sidewalls have frosted surfaces for reflecting the light beams to assure output of the light beams through the light emitting surface.

### BACKGROUND OF THE INVENTION

1. Field of the Invention

The present invention relates to a light guide plate having more efficient light utilization and light output, and further relates to a surface light source device employing the light guide plate for back-lighting or front-lighting a liquid crystal display (LCD).

2. The Related Arts

One kind of surface light source device comprises a light guide plate having an end face, through which light is introduced, and two major faces, one of which provides an emission face. These surface light source devices are employed in back-lighting or front-lighting a liquid crystal display. The performance of such surface light source devices greatly depends on the light guide plate employed therein.

A light guide plate functions to change a propagation direction of light beams introduced into the light guide plate through a side end face from a direction roughly parallel to an emission face of the light guide plate to a direction perpendicular to the emission face. As is well known, a simple, transparent light guide plate without any modification is capable of deflecting light little, and therefore provides unsatisfactory brightness through the emission face. Consequently, means for promoting emission through the emission face is required.

A conventional light guide plate module 10 (shown in FIG. 8) described in U.S. Pat. No. 5,947,578 includes a light guide plate 12 and a frame member 14 for mounting the light guide plate 12 therein. The frame member 14 has inside frame edges 15 which are either coated with a diffusively reflective material, or are made of an inherently diffusively reflective material. The inside edges 15 reflect any light transmitted out through sidewalls (not labeled) of the light guide plate 12 back into the light guide plate 12 so that the light is reflected within the light guide plate 12 or by a lower surface 18 so that it is eventually emitted through an upper surface 17. The conventional light guide plate module 10 suffers from light loss associated with inefficient coupling of the light guide plate 12 and the inside edges 15 of the frame member 14. Furthermore, the frame member 14 increases a size and a cost of the light guide plate 12.

In another design, a seal bar may be used to prevent light loss through sidewalls of a light guide plate. The seal bar adheres to the sidewalls but can easily fall off during carrying of the light guide plate, and may not cover the sidewalls completely. Thus, the light utilization efficiency is low in this light guide plate design.

An improved light guide plate that overcomes the above-mentioned disadvantages is desired.

### SUMMARY OF THE INVENTION

An object of the present invention is to provide an improved light guide plate for a surface light source device used with an LCD panel, which light guide plate more efficiently utilizes light and provides greater light output for a given light input.

Another object of the present invention is to provide a light guide plate, which has a small size and a low price.

To achieve the above-mentioned objects, a light guide plate comprises an incident surface for receiving the light beams from a light source; a light emitting surface for transmitting light beams outwardly; a bottom surface opposite to the light emitting surface for reflecting the light beams to the light emitting surface; and a plurality of sidewalls perpendicular to the light emitting surface. The sidewalls have frosted surface texture for reflecting the light beams to assure that the light beams are emitted through the light emitting surface of the light guide plate.

The light guide plate may be employed in a surface light source device for back-lighting or front-lighting an LCD panel. When so used, the performance of the surface light source device is increased since the light guide plate illuminates the surface light source device uniformly.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a light guide plate in accordance with a preferred embodiment of the present invention;

FIG. 2 is a right end view of the light guide plate of FIG. 1;

FIG. 3 is a back end view of the light guide plate of FIG. 1;

FIG. 4 is a perspective view of a second embodiment of a light guide plate according to the present invention;

FIG. 5 is a right end view of the light guide plate of FIG. 4;

FIG. 6 is a back end view of the light guide plate of FIG. 4;

FIG. 7 is an exploded, perspective view of a third preferred embodiment of a surface light source device according to the present invention; and

FIG. 8 is a perspective view of a prior art light guide plate.

### DETAILED DESCRIPTION OF THE PREFERRED EMBODIMENT

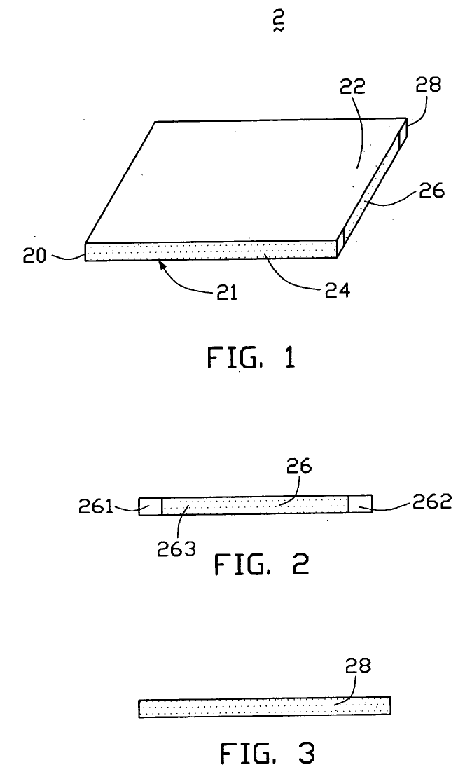

As shown in FIG. 1, a light guide plate 2 of the present invention is made of a light transmitting synthetic resin, such as an acrylic resin, a polycarbonate, or the like. The light guide plate 2 comprises an incident surface 20 for introducing light beams into the light guide plate 2 from a light source (not shown), a bottom surface 21 for totally reflecting the light beams transmitted inside the light guide plate 2, and a light emitting surface 22 opposite to the bottom surface 21. The incident surface 20 is between the bottom surface 21 and the light emitting surface 22. A plurality of antireflective films (not labeled) are bonded to the incident surface 20 and the light emitting surface 22, respectively, which prevent the light beams from being reflected back and improve a light transmission ratio.

The light guide plate 2 further comprises a first sidewall 24, a second sidewall 26 and a third sidewall 28, which are perpendicular to the light emitting surface 22. The first sidewall 24 and the third sidewall 28 are perpendicular to the second sidewall 26 and to the incident surface 20. The first, third and second sidewalls 24, 28, 26 define two “cross corners” at their junctions. The first and the third sidewalls 24, 28 have frosted surfaces for reflecting light beams. The second sidewall 26 has two unfrosted ends 261, 262 at two corners thereof, and a frosted surface 263 between the two unfrosted ends 261, 262. A length of each of the two unfrosted ends 261, 262 is approximately 10% of a length of the second sidewall 26, respectively. The two unfrosted ends 261, 262 efficiently prevent the light beams from being reflected twice at the two corners, preventing the signals from interfering.

In operation, when light beams from a light source are introduced into the light guide plate 2 through the incident surface 20, most light beams impinging on the bottom surface 21 are totally internally reflected in the light guide plate 2, and upwardly propagate toward the emitting surface 22, and are uniformly output from the emitting surface 22 of the light guide plate 2. A part of the light beams impinging on the first, second and third sidewalls 24, 26, 28 are reflected back into the light guide plate 2 by the frosted surfaces of the sidewalls 24, 26, 28. This decreases loss of the light beams.

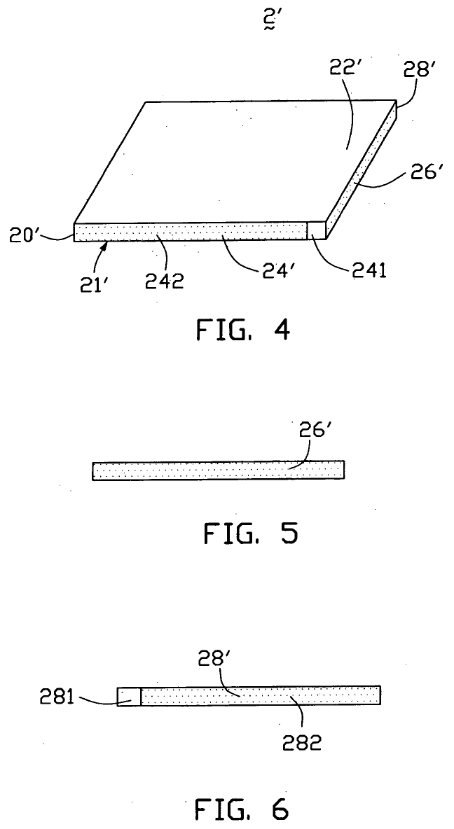

Referring to FIGS. 4-6, an alternative embodiment of a light guide plate 2′ in accordance with the present invention has a structure similar to that of the light guide plate 2. The light guide plate 2′ comprises a first sidewall 24′, a second sidewall 26′ and a third sidewall 28′, all being perpendicular to the light emitting surface 22′. The first sidewall 24′ and the third sidewall 28′ are each perpendicular to the second sidewall 26′, two “cross corners” (not labeled) being defined at their junctions. The second sidewall 26′ has a frosted surface for reflecting light beams. The first sidewall 24′ has a frosted surface 242 for reflecting light beams and an unfrosted end 241 at the cross corner defined at the junction of the first and second sidewall 24′, 26′. The third sidewall 28′ has a frosted surface 282 for reflecting light beams and an unfrosted end 281 at the cross corner defined at the junction of the third and second sidewalls 28′, 26′. A length of the two unfrosted ends 241, 281 is each approximately 10% of a length of the first sidewall and the third sidewalls 24′, 28′, respectively. Each can efficiently prevent the light beams from being reflected twice at the two cross corners, preventing the signals from interfering.

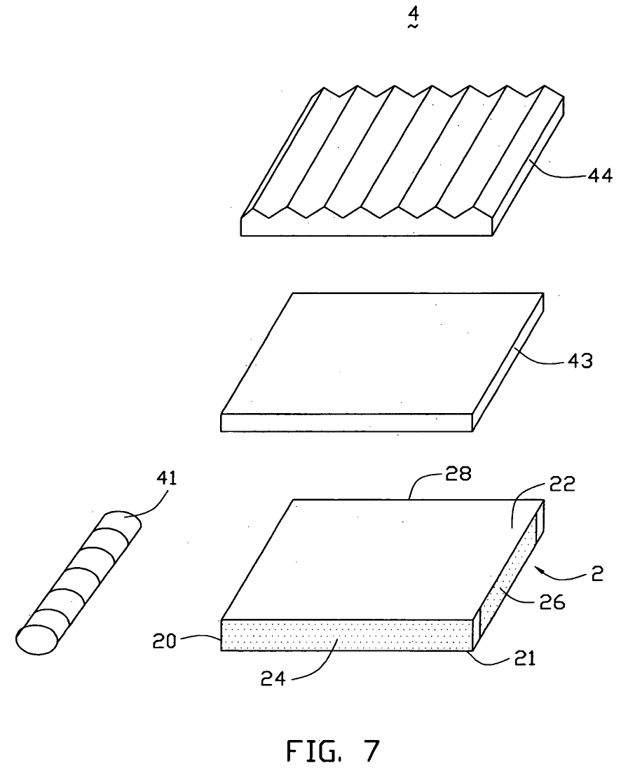

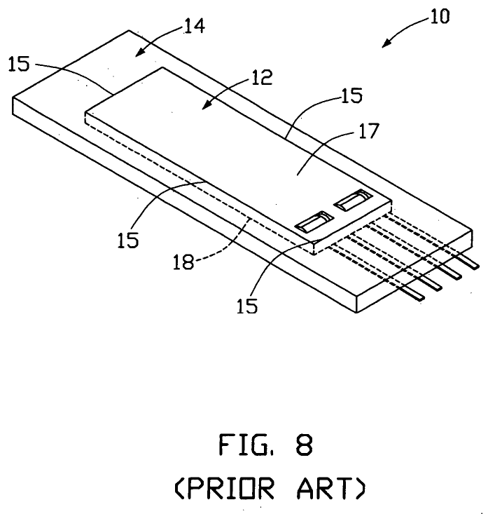

FIG. 7 shows a surface light source device 4 employing the light guide plate 2 according to the present invention. The surface light source device 4 has a light source 41 emitting light beams, the light guide plate 2 for changing a transmission direction of the light beams, a diffusion sheet 43 and a prism plate 44. The diffusion sheet 43 and the prism plate 44 are disposed on the light emitting surface 22 of the light guide plate 2 laminatedly arranged in order. The light source 41 is arranged along the incident surface 20 of the light guide plate 2, and may be a hot cathode ray tube or a cold cathode ray tube. The surface light source device 4 further includes a curved reflection mirror (not shown) enclosing the light source 41 on three sides, so as to efficiently utilize the light beams emitted by the light source 41.

In operation, the light beams from the light source 41 propagate into the light guide plate 2 directly, or indirectly by reflection off the curved reflection mirror. The light guide plate 2 changes a propagation direction of the light beams from a direction roughly parallel to the light emitting surface 22 to a direction perpendicular to the light emitting surface 22. Moreover, a part of the light beams impinging on the first, second and third frosted sidewalls 24, 26, 28 will be reflected back into the light guide plate 2 by the frosted surfaces of the sidewalls 24, 26, 28, thereby, prohibiting the light beams from leaking, i.e. being lost to an outside. After that, the light beams are transmitted first into the diffusion sheet 43 and next into the prism plate 44, which respectively diffuses the light beams homogeneously and directs the light beams in a desired angular range. Then, the light beams are output uniformly.

The light guide plate 2 of the preferred embodiment of the present invention has the following advantages. By utilization of a plurality of frosted sidewalls of the light guide plate, no light is lost by transmission through the sidewalls of the light guide plate. Accordingly, light is more efficiently utilized and a greater light output is obtained for a given light input. Furthermore, the frosted sidewalls are easily formed and no other means is needed. Consequently, the light guide plate 2 is small in size and low in cost. The above-described benefits are equally applicable to the light guide plate 2′ and the surface light source 4 of the present invention.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

We claim:

1. A light guide plate into which light beams are introduced from a light source comprising:
an incident surface receiving the light beams from the light source;
a light emitting surface transmitting the light beams therethrough;
a bottom surface opposite to the light emitting surface for reflecting the light beams to the light emitting surface; and
a plurality of sidewalls perpendicular to the light emitting surface, wherein the sidewalls have frosted surfaces for reflecting the light beams to assure that the light beams are output through the light emitting surface.

2. The light guide plate as claimed in claim 1, wherein adjacent sidewalls are perpendicular to each other and defines a cross corner at their junction.

3. The light guide plate as claimed in claim 2, wherein one of the sidewalls in each pair of perpendicular sidewalls comprises an unfrosted end at the cross corner.

4. The light guide plate as claimed in claim 3, wherein a length of the unfrosted end is approximately 10% of a length of the sidewall.

5. The light guide plate as claimed in claim 1, wherein a first and second anti-reflection films are bonded on the incident surface and the light emitting surface, respectively.

6. A surface light source for providing light beams to an LCD panel, comprising:
a light source emitting light beams; and
a light guide plate, which comprises:
an incident surface receiving the light beams from the light source;
a light emitting surface transmitting light beams therethrough;
a bottom surface opposite to the light emitting surface for reflecting the light beams to the light emitting surface; and
a plurality of sidewalls perpendicular to the light emitting surface, wherein the sidewalls have frosted surfaces for reflecting the light beams impinging on the sidewalls to assure that the light beams are output through the light emitting surface.

7. The surface light source as claimed in claim 6, wherein the adjacent sidewalls are perpendicular to each other and each pair of adjacent sidewalls define a cross corner.

8. The surface light source as claimed in claim 7, wherein one of two perpendicular sidewalls comprises an unfrosted end at the cross corner.

9. The surface light source as claimed in claim 8, wherein a length of the unfrosted end is approximately 10% of a length of the sidewall.

10. The surface light source as claimed in claim 6, wherein anti-reflection films are plated on the incident surface and the light emitting surface, respectively.

11. A light guide plate into which light beams are introduced from a light source comprising:
an incident surface receiving the light beams from the light source;
a light emitting surface transmitting the light beams therethrough;
a bottom surface opposite to the light emitting surface for reflecting the light beams to the light emitting surface; and
a plurality of sidewalls perpendicular to the light emitting surface, wherein at least one of the sidewalls has a frosted surface for reflecting the light beams to assure that the light beams are output through the light emitting surface.

12. The light guide plate as claimed in claim 11, wherein said frosted surface is terminated with a distance spaced from a corresponding corner of said light guide plate.
